(19) United States
(12) Patent Application Publication
(10) Pub. No.: US 2010/0091790 A1
(43) Pub. Date: Apr. 15, 2010

(54) Patch identification beacon

(75) Inventors: Michael Wasielewski, JR., McLean, VA (US); Daniel McHugh, Arlington, VA (US)

Correspondence Address: OLIFF & BERRIDGE, PLC, P.O. BOX 320850, ALEXANDRIA, VA, 22320-4850, US

(73) Assignee: LOCKHEED MARTIN CORPORATION, BETHESDA, MD (US)

(21) Appl. No.: 12/285,834

(22) Filed: Oct. 15, 2008

(51) Int. Cl. H04L 12/66

(52) U.S. Cl. 370/463

(57) ABSTRACT

Aspects of the disclosure provide a patch identification beacon (PIB) device that can enable location tracking with reduced time and cost. The PIB device can include a first interface coupled to a network. The first interface can be configured to receive signals from the network, and transmit signals to the network. Further, the PIB device can include a second interface coupled to an electronic device, and a controller configured to govern the first interface to transmit a programmable identifier associated with the electronic device over the network.

### BACKGROUND

Network and computer engineers may need to track a device location information, such as a port number, a patch panel on a wall, a physical room, and the like, in order to trouble shoot problems. In a tracking mechanism, a device may be configured during an installation according to a location tracking standard. The configuration may require coherent adherence to the location tracking standard, and can be time consuming.

### SUMMARY

Aspects of the disclosure can provide a patch identification beacon (PIB) device that can enable location tracking with reduced time and cost. The PIB device can include a first interface coupled to a network. The first interface can be configured to receive signals from the network, and transmit signals to the network. Further, the PIB device can include a second interface coupled to an electronic device, and a controller configured to govern the first interface to transmit a programmable identifier associated with the electronic device over the network.

According to an aspect of the disclosure, the identifier can be programmed to include physical location information of the PIB device (i.e. “Room 107” or “Jake Boczany's Office”), and can be programmed to include an identification of the electronic device.

Further, the network can be at least one of an Ethernet network, a telephone network, and a cable network.

In an embodiment, the controller can be configured to govern the first interface to transmit the identifier periodically. In another embodiment, the controller can be configured to transmit the identifier in response to a query.

According to the disclosure, the identifier can be transmitted in a packet. The PIB device may include a buffer configured to buffer incoming packets for transmitting when the packet including the identifier is generated and transmitted.

According to an aspect, the identifier may include an IP address assigned to the PIB device to make the PIB device IP addressable. Alternatively, the PIB device may not be IP addressable. According to another aspect, the identifier can be transmitted over a sub-wire of an existing communication link that is not used by other network traffic. Alternatively, the identifier can be transmitted over a sub-wire that is used by other network traffic.

Aspects of the disclosure can also provide a method for detecting device location. The method can include receiving a signal that includes an identifier associated with an electronic device from a network. The signal can be transmitted by a patch identification beacon (PIB) device coupled to the network. The PIB device can include a first interface configured to receive signals from the network, and transmit signals to the network, a second interface coupled to the electronic device and a controller configured to govern the first interface to transmit the signal including the identifier of the PIB device associated with the electronic device.

Further, the method can include transmitting a query signal. The query signal can be received by the PIB device, and the PIB device can transmit the signal including the identifier associated with the electronic device in response to the query signal.

Additionally, the identifier may be included in a packet for transmission. The packet can be formed according to Internet protocols, such as Internet control message protocol (ICMP).

### BRIEF DESCRIPTION OF THE DRAWINGS

Various exemplary embodiments of this disclosure will be described in detail with reference to the following figures, wherein like numerals reference like elements, and wherein:

FIG. 1 is a diagram of an exemplary network system that includes a network controller and a plurality of patch identification beacon (PIB) devices;

FIG. 2A is a diagram of an exemplary patch panel provided with a straight, in-line PIB device;

FIG. 2B is a diagram of an exemplary wall socket provided with a PIB device bent at a 90° angle;

FIG. 3 is a block diagram of an exemplary PIB device;

FIG. 4 is a flow chart outlining an exemplary communication process of a PIB device;

FIG. 5 is a diagram of an exemplary packet of an Internet control message protocol (ICMP) message from a PIB device according to an embodiment of the disclosure; and

FIG. 6 is a diagram of an exemplary communication process of a vendor device with a PIB device according the disclosure.

### DETAILED DESCRIPTION OF EMBODIMENTS

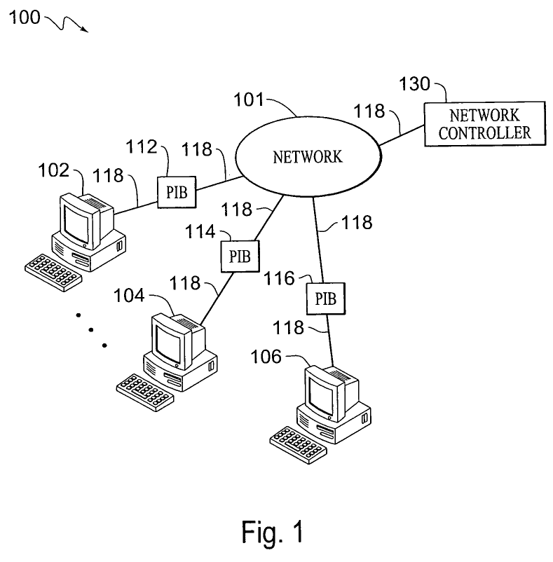

FIG. 1 shows a diagram of an exemplary network system. The network system 100 may include a plurality of patch identification beacon (PIB) devices 112-116, a plurality of terminal devices 102-106, a network 101 and a network controller 130. These elements can be coupled together as shown in FIG. 1.

The plurality of terminal devices 102-106 can be devices of any type that can allow for the transmission and/or reception of information. For example, the plurality of terminal devices 102-106 can include customer premises equipment (CPE), CPE Modems, Digital Subscriber Line (DSL) Equipment, DSL Systems, Cable Modems, Set-top boxes, telephones, wireless telephones, cellular telephones, Personal Digital Assistants (PDAs), computer terminals, database terminals, pages, printers, facsimile machines, answering machines and the like. For ease and clarity, the plurality of terminal devices 102-106 are presented as personal computers in FIG. 1.

As shown in FIG. 1, a terminal device of 102-106 can be coupled to a PIB of 112-116, for example via a communication link 118. Further, the PIB can be coupled to the network 101, for example via a communication link 118. A communication link 118 can be any type of link that can allow for the transmission of information, such as conventional telephone lines, digital transmission facilities, fiber optic lines, direct serial/parallel connections, cellular telephone links, satellite communication links, any local area networking (LAN) technology such as Ethernet, Intranets and the like. A communication link 118 may include multiple sub-links, such as sub-wires. For example, an Ethernet link can generally include 8 copper wires. The 8 copper wires can be used differently according to different Ethernet communications. For example, a 10/100 Mbit Ethernet communication may use a subset of the 8 copper wires, such as 4 of the 8 copper wires. In another example, a Gigabit Ethernet communication may use all 8 copper wires.

The network 101, may be a single network or a plurality of networks of the same or different types. For example, the network 101 may include an Ethernet network. Further, the network 101 maybe any type of data network, a telephone communication network, or a video distribution network (e.g., cable, terrestrial broadcast or satellite) in connection with the data network. Any combination of telecommunication, video/audio distribution and data networks, whether a global, national, regional, wide-area, local area, or in-home network, may be used without departing from the spirit and scope of the present disclosure. For the purposes of discussion, it will be assumed that the network 101 is an integrated Ethernet network.

A PIB device of 112-116 can be situated anywhere between the network 101 and a terminal device. A PIB device of 112-116 may include a programmable identifier, such as a text string. The programmable identifier can be interpreted by the network 101 or the terminal device. In an embodiment, the programmable identifier can be programmed at a time of installation to include location information of the PIB device. In another example, the programmable identifier can be updated when a terminal device is plugged in the PIB device, such as to include a MAC of the terminal device. In another example, the programmable identifier can be programmed by a remote controller, such as the network controller 130, for example, to include an assigned IP address.

Further, the PIB device of 112-116 may transmit the programmable identifier. In an embodiment, the PIB device may transmit the programmable identifier periodically, such as based on a schedule. In another embodiment, the PIB device may transmit the programmable identifier in response to a query.

Additionally, the PIB device of 112-116 may transmit the programmable identifier over a sub-wire of an existing communication link with other network traffic or may transmit the programmable identifier over a sub-wire of the existing communication link without other network traffic. In an embodiment, the PIB device may transmit the programmable identifier using at least one of the 4 copper wires used by the 10/100 Mbit Ethernet communication or at least one of the 8 copper wires used by the Gigabit Ethernet communication. In another embodiment, the PIB device may transmit the programmable identifier using at least one of the 4 copper wires that are not used by the 10/100 Mbit Ethernet communication.

According to aspects of the disclosure, the PIB device of 112-116 may transmit the programmable identifier as a binary string, or may transmit the programmable identifier in a packet form according to a communication protocol.

While the PIBs 112-116 are shown as independent units coupled to the network 101, it should also be understood that they may be incorporated into the terminal devices 102-106 and/or may be distributed throughout the network 101. For example, PIB 112 may be a part of a central server (not shown) employed by the network 101, which is distributed in the network 101 with other central servers.

The network controller 130 can be a network switch or a terminal device that can obtain information including PIB identifiers of the PIB devices 112-116 from the network 101. The PIB identifiers can be associated with terminal devices 102-106, respectively. Additionally, the PIB identifiers may include physical location information of the PIB devices 112-116, respectively. Therefore, the network controller 130 can obtain information of the terminal devices 102-106 with respective physical locations.

A PIB device of 112-116 may or may not affect network traffic. In an embodiment, a PIB device may use a sub-wire of an existing communication link that is not used by other network traffic, thus the PIB device may not affect other network traffic. In another embodiment, a PIB device may use a sub-wire of an existing communication link that is used by other network traffic. In such embodiment, the PIB device may operate in an active mode or an in-active mode. In the in-active mode, the PIB device may allow network traffic pass through, and may not affect the network traffic. In the active mode, the PIB device may act on the network traffic. For example, the PIB device may generate a packet and inject the packet in the network traffic. Additionally, the PIB device may buffer incoming packets to wait for the generation and injection of the PIB packet.

Additionally, a PIB device of 112-116 can be powered by the communication link 118, such as power over Ethernet (PoE). Alternatively, the PIB device can be powered by any type of internal or external power supply.

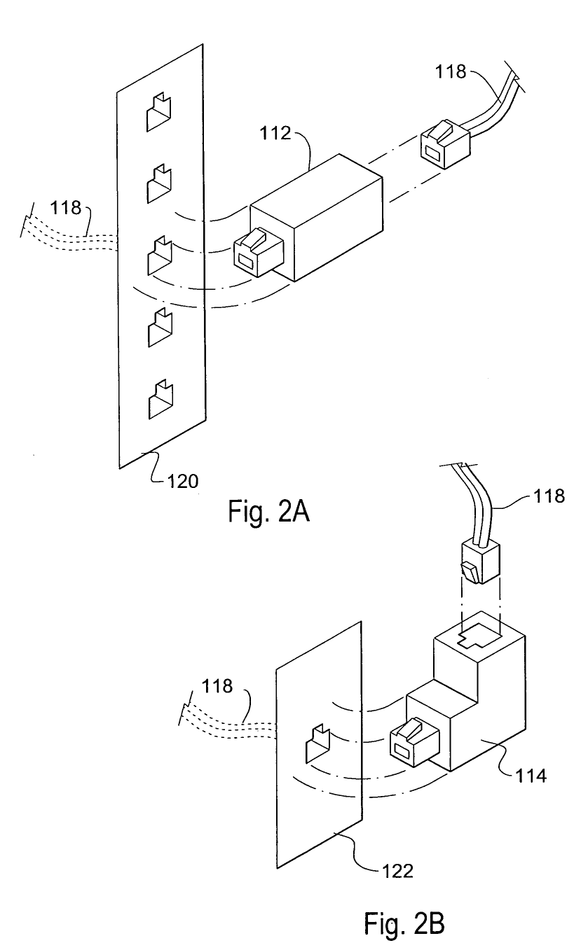

FIG. 2A shows a diagram of an exemplary patch panel 120 provided with a straight, in-line PIB device 112 and FIG. 2B shows a diagram of an exemplary wall socket 122 provided with a PIB device 114 bent at a 90° angle. Additionally, a PIB device can be customized in any suitable shape in addition to the straight in-line shape and the bent 90° angled shape.

A PIB device can be a separate device from the patch panel and the wall socket, such as shown in FIG. 2A and FIG. 2B. The PIB device can be plugged in a patch panel or a wall socket and can be programmed accordingly. It is noted that a PIB device can be integrated with a patch panel, a wall socket, network device, terminal device, and the like.

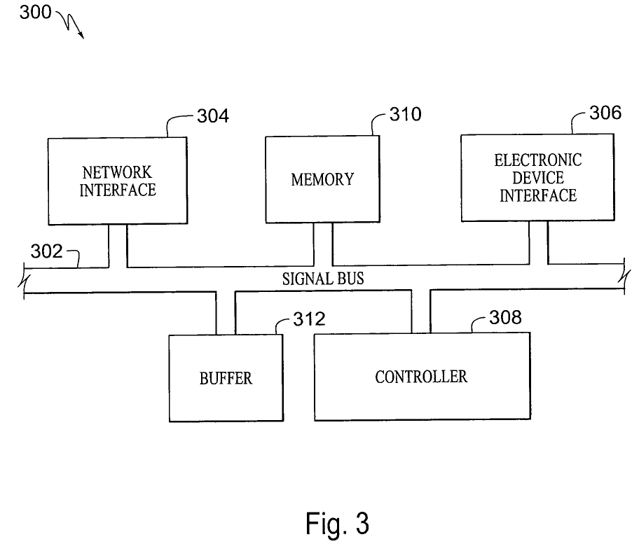

FIG. 3 shows a block diagram of an exemplary PIB device. The PIB device 300 can include a network interface 304, an electronic device interface 306, and a controller 308. These elements can be coupled together via a signal bus 302. Additionally, the PIB device 300 may also include a memory 310 and a buffer 312 coupled to the controller 308. In an example, at least a portion of the memory 310 can be configured as the buffer 312.

The network interface 304, such as an Ethernet interface, can be coupled to a network, and can receive information from the network and transmit information to the network. The network interface 304 may be coupled to a communication link. The communication link may include multiple sub-wires. Some sub-wires can be used for other network traffic, and some sub-wires may be not used for other network traffic. The network interface 304 may be configured in an In-Band configuration and an Out-of-Band configuration with regard to the other network traffic. In the In-Band configuration, the network interface 304 may transmit information on a sub-wire that is used by other network traffic. In the Out-of-Band configuration, the network interface 304 may transmit information on a sub-wire that is not used by other network traffic.

The electronic device interface 306 can be coupled to an electronic device, and can receive information from the electronic device and transmit information to the electronic device. For example, after an electronic device is plugged in the electronic device interface 306, the electronic device may transmit information, such as its MAC, to the electronic device interface 306 to update the programmable identifier, in order to associate the programmable identifier with the electronic device. In another example, a plugged-in electronic device may obtain the programmable identifier from the PIB device.

The controller 308 may enable elements of the PIB 300 to operate in various modes, such as active mode, in-active mode, and the like. The memory 310 may stored the programmable identifier, and the buffer 312 may buffer incoming packets. Additionally, the PIB 300 may include a user interface (not shown). The user interface can enable a user to program the identifier, for example at the time of installation, to include location information.

The PIB device 300 may operate in a broadcasting manner or a query manner. In the broadcasting manner, the network interface 304 can receive packets being transmitted on the network 101. Further, the network interface 304 can convey the received packets to the controller 308 via the signal bus 302. The controller 308 can determine whether it is time to inject the PIB identifier. When it is time to inject the identifier, the controller 308 can buffer the received packets, for example in the buffer 312. Additionally, the controller 308 may generate an identifier based on the stored information. The identifier can be combined with the received packets or can be sent separately. The controller 308 may send the identifier to the network interface 304. The network interface 304 can then transmit the identifier over the network 101. Subsequently, the controller 308 can govern the interfaces to transmit the buffered packets, for example. On the other hand, when it is not time to send the identifier, the controller 308 can convey the received packets.

In the query manner, the network interface 304 can convey the received packets to the buffer 312 via the signal bus 302, for example. The controller 308 may be configured to determine whether the received packets may include a query for PIB identifiers. For example, a packet may include a PIB identifier query field that can include a query state. The PIB identifier query field may be examined by the PIB device 300 to determine if its PIB identifier is queried. When the PIB identifier is queried, the controller 308 may generate an identifier. The identifier can be combined with the received packets or can be sent separately. Otherwise, the controller 308 may convey the packets without actions on the PIB identifiers.

The PIB device 300 can be configured into different models according to various aspects, such as In-Band vs. Out-of-Band, IP-addressable vs. non IP-addressable, and the like. Different models can operate differently.

When the PIB device 300 is configured in an Out-of-Band model, the PIB device 300 may inject information in one or more sub-wires that are not used by other network traffic. For example, the PIB device 300 may inject information in one or more of the 4 copper wires that are not used by the standard 10/100 Mbit Ethernet communication.

Further, the PIB device 300 of Out-of-Band model can operate in a simple manner. In an example, the PIB device 300 may broadcast a beacon hello with the identifier on at least one of the unused sub-wires of an existing communication link. Thus, everyone in the local network may be able to see the identifier.

In another example, the PIB device 300 of Out-of-Band model may transmit the identifier in response to a query. The query may be sent by a vendor device or other suitable device over the unused sub-wires of an existing communication link. The PIB device 300 can watch for bit patterns corresponding to an identifier query. When the PIB device 300 detects an identifier query, the PIB device 300 may construct a bit stream including the identifier. Additionally, the bit stream may include bit patterns indicative of start and end of the bit stream. Then, the PIB device 300 may transmit the bit stream over at least one of the unused sub-wires of an existing communication link.

When the PIB device 300 is configured in an In-Band model, information being injected by the PIB device 300 can be transmitted over sub-wires of an existing communication link, with other network traffic, such as in a Gigabit Ethernet communication. The Gigabit Ethernet communication can use all 8 copper wires of an Ethernet link. Therefore, the information being injected by the PIB device 300 may be transmitted with other network traffic. In another Ethernet example, a standard 10/100 Mbit Ethernet communication may use 4 of the 8 copper wires. The PIB device 300 may inject information in one or more of the 4 wires that are used by the standard 10/100 Mbit Ethernet communication. Thus, the information being injected by the PIB device 300 may be transmitted with other Ethernet traffic. The PIB device of In-Band model may transmit the identifier in the form of a packet.

When the PIB device 300 is configured in an IP-addressable model, the identifier of the PIB device 300 may include an IP address. The IP address may enable the PIB device 300 to be identified on the network, and may enable communications beyond local network.

In an embodiment, the PIB device 300 of the IP-addressable model can be configured by a remote controller on the network. Additionally, the PIB device 300 may operate according to internet protocols, such as an Internet control message protocol (ICMP), and the like, and may receive a query from a device situated anywhere in the network. Further, the identifier of the PIB device 300 may be routed anywhere in the network.

When the PIB device 300 is configured in a non IP-addressable model, the PIB device 300 can operate in a broadcast manner or a query manner. In the broadcast manner, the PIB device 300 may broadcast its identifier on a local network. In the query manner, the PIB device 300 may listen to the sub-wire for query. When a query is detected, the PIB device 300 may transmit the identifier in a packet form or in a bit stream form.

Additionally, the PIB device 300 may be configured according to permutation of the various aspects, such as an In-Band IP-addressable model, an In-Band non IP-addressable model, an Out-of-Band IP-addressable model, and an Out-Band non IP-addressable model.

When the PIB device 300 is configured in In-Band non IP-addressable model, the PIB device 300 may operate in a broadcast manner or in a query manner. In the broadcast manner, the PIB device 300 may broadcast its identifier in the form of either packet or bit stream on the local network. In the query manner, the PIB device 300 may listen to a query from the local network. When the PIB device 300 detects a query, the PIB device 300 may watch the line for quiet periods to send a bit stream or packet. Alternatively, the PIB device 300 may buffer incoming packets, and send a bit stream or packet that can include its identifier.

When the PIB device 300 is configured in In-Band IP-addressable model, the PIB device 300 may be controlled, configured, and queried by controllers anywhere on the network. The PIB device 300 may work in a query manner. In the query manner, the PIB device 300 may listen to a query that may come from anywhere in the network, such as a central repository manager in the network. When the PIB device 300 detects a query, the PIB device 300 may generate a packet to include its identifier, and transmit the packet on the network with other network traffic. The packet can be routed to a destination anywhere in the network.

When the PIB device 300 is configured in Out-of-Band non IP-addressable model, the PIB device can send out a bit stream on unused sub-wires to announce its identifier. The identifier can be received by a device on the local network that listens to the unused sub-wires.

When the PIB device 300 is configured in Out-of-Band IP-addressability model, the PIB device 300 may listen to a query that may come from anywhere in the network, such as a central repository manager in the network. When the PIB device 300 detects a query, the PIB device 300 may be able to send its identifier on unused sub-wires.

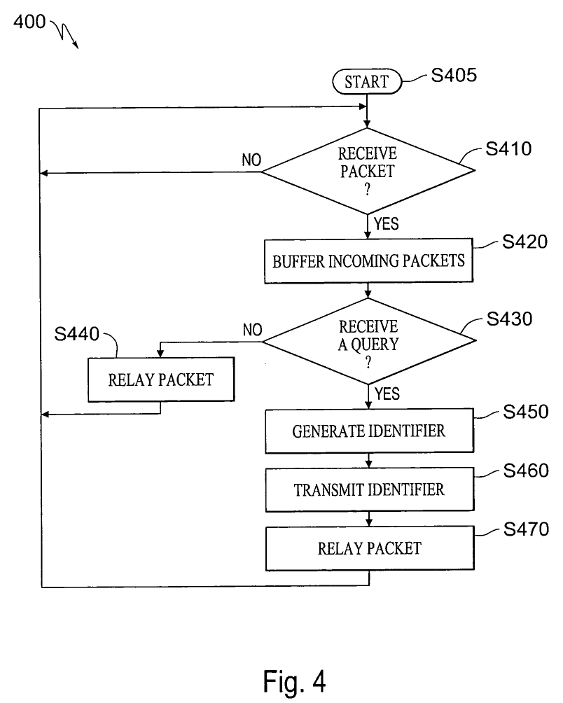

FIG. 4 shows a flow chart outlining an exemplary process for a PIB device to transmit a programmable identifier. The process starts at step S405, and proceeds to step S410.

In step S410, the PIB device may monitor its interfaces for incoming packets. When there is no incoming packet, the PIB device may continue monitoring. When the PIB device receives an incoming packet, the process proceeds to step S420.

In step S420, the PIB device may buffer the incoming packet. The incoming packet may come from various network devices, such as end users and network units, and may transmit to various network devices. The process then proceeds to step S430.

In step S430, the PIB device may detect whether a buffered packet includes a query for its programmable identifier. For example, the PIB device may check a specific field of a packet. When the PIB device detects a query, the process proceeds to step S450, otherwise the process proceeds to step S440.

In step S450, the PIB device may generate a packet that includes its programmable identifier. For example, the PIB device may generate a packet having a field for the programmable identifier. In another example, the PIB device may insert or append the programmable identifier in an existing packet. Then, the process proceeds to step S460.

In step S460, the PIB device may transmit the generated packet into the network. Then, the process proceeds to step S470, where the PIB device can transmit the buffered packet. It is noted that the PIB device may generate the packet and transmit the packet at the same time when the PIB device receives and buffers more incoming packets.

In step S440, the PIB device may transmit the buffered packets. The process returns to step S410.

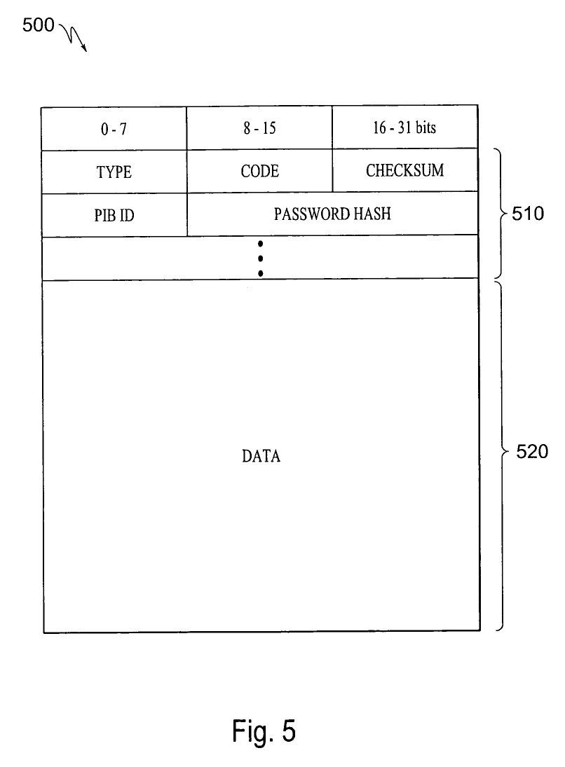

FIG. 5 shows an exemplary packet 500 for a PIB ICMP message according to an aspect of the disclosure. The packet 500 can include a header portion 510 and a data portion 520. The header portion 510 can include information related to control and identification of the ICMP message, such as an ICMP type field, a code field, a checksum field, a PIB ID field, a Password Hash field, and the like. The ICMP type and code fields can be set according to standard protocol (for example, Type: 155 in IPv6, 55 in IPv4 and Code: 0). The checksum field can include error-checking data calculated from the ICMP header portion 510 and data portion 520. The checksum field may be calculated according to standards, such as RFC 2463 (IPv6) or RFC 1624 (IPv4), for example. The PIB ID field can include the programmable identifier for the PIB device. The PIB ID field may include IP address, MAC assigned to the PIB, and the like. The password hash field may be used to prevent spoofing by providing an optional string that can be used to configure the PIB or to identify the PIB as being the one that sent the message. The data portion 520 can include information stored in the PIB. If the information is less than the total available space, it can be padded.

A PIB enabling device, such as an access-layer switch, a proprietary device and the like, can be used by network and computer engineers to obtain information stored at a PIB device, in order to identify a terminal device plugged in the PIB device and its location. The access-layer switch can be a switch that can integrate PIB communication functions with other switch functions. The proprietary device can be a device that may only include PIB communication functions. The PIB enabling device may be configured to operate according to the PIB device model.

When the PIB devices are configured in Out-of-Band model, the PIB enabling device may be configured to listen to sub-wires without other network traffic. The PIB enabling device may receive bit streams form the sub-wires, and may identify bit patterns according to a pre-defined standard. For example, a bit stream may include a bit pattern indicative of a start of the bit steam, and a bit pattern indicative of an end of the bit stream. Additionally, the bit stream may include a bit pattern for a PIB identifier.

When the PIB devices are configured in In-Band non IP-addressable model, the PIB enabling device can wait for broadcasts of the PIB devices or can send query to the PIB devices, such as multi-casting queries.

When the PIB devices are configured in In-Band IP-addressable model, the PIB enabling device can communicate with the PIB devices similar to other devices with an IP address. In an example, the PIB enabling device can send a packet to a PIB device. The packet may include a query to the PIB device, thus the PIB device may respond with a response packet. Additionally, the packet may include configuration data to the PIB device, thus the PIB device may be configured accordingly.

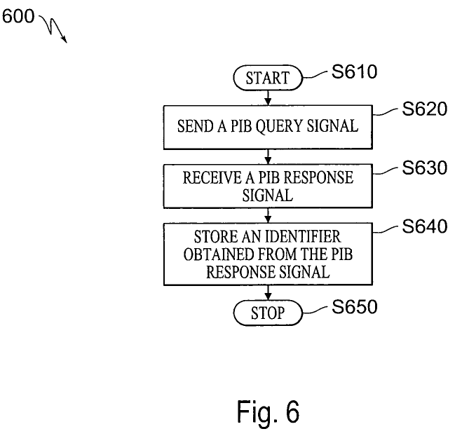

FIG. 6 shows a flowchart outlining an exemplary process for a PIB enabling device to communicate with a PIB device. The process starts at step S610, and proceeds to step S620.

In step S620, the PIB enabling device may send a query signal to a PIB device. The query signal may be a bit stream or a packet. Additionally, the query signal can be sent with an IP address to an IP-addressable PIB device, or can be sent via multi-casting to multiple addresses. Then, the process proceeds to step S630.

In step S630, the PIB enabling device may receive a PIB response signal. The PIB response signal may be a bit stream or a packet. The PIB response signal can include an identifier of a PIB device that can be used to identify a terminal device plugged in the PIB device and the location of the PIB device. The process then proceeds to step S640.

In step S640, the PIB enabling device may obtain the identifier from the PIB response signal, and may store the identifier. The PIB enabling device may receive multiple response signals from multiple PIB devices. The PIB enabling device may combine identifiers from the multiple response signals, and provide the combined identifiers to an administrator to diagnose network issues. The process then proceeds to step S650, and terminates.

While the invention has been described in conjunction with the specific exemplary embodiments thereof, it is evident that many alternatives, modifications, and variations will be apparent to those skilled in the art. Accordingly, exemplary embodiments of the invention as set forth herein are intended to be illustrative, not limiting. There are changes that may be made without departing from the spirit and scope of the invention.

What is claimed is:

1. A patch identification beacon (PIB) device, comprising:
a first interface coupled to a network, the first interface being configured to receive signals from the network, and transmit signals to the network;
a second interface coupled to an electronic device; and
a controller configured to govern the first interface to transmit a programmable identifier associated with the electronic device over the network.

2. The PIB device of claim 1, wherein the identifier is programmed to include physical location information of the PIB device.

3. The PIB device of claim 1, wherein the identifier is programmed to include an identification of the electronic device.

4. The PIB device of claim 1, wherein the network is at least one of an Ethernet network, a telephone network, and a cable network.

5. The PIB device of claim 1, wherein the controller is configured to govern the first interface to transmit the identifier periodically.

6. The PIB device of claim 1, wherein the controller is configured to transmit the identifier in response to a query.

7. The PIB device of claim 1, wherein the identifier is transmitted within a packet.

8. The PIB device according to claim 7, further comprising:
a buffer configured to buffer incoming packets for transmitting when the packet is generated and transmitted.

9. The PIB device of claim 1, wherein the identifier includes an IP address assigned to the PIB device.

10. The PIB device of claim 1, wherein the electronic device is at least one of a computer, a customer premises equipment (CPE), a CPE Modem, a Digital Subscriber Line (DSL) Equipment, a DSL System, a Cable Modem, a Set-top box, a telephone, a wireless telephone, a Personal Digital Assistants (PDAs), a database terminal, a printer, a facsimile machine, and an answering machine.

11. The PIB device of claim 1, wherein the identifier is transmitted over a sub-wire of an existing communication link that is not used for other network traffic.

12. The PIB device of claim 1, wherein the identifier is transmitted over a sub-wire of an existing communication link that is used for other network traffic.

13. A method for detecting location, comprising:
receiving a signal including an identifier associated with an electronic device from a network, the signal being transmitted by a patch identification beacon (PIB) device coupled to the network, wherein the PIB device comprises:
a first interface configured to receive signals from the network, and transmit signals to the network, a second interface coupled to the electronic device and a controller configured to govern the first interface to transmit the signal including the identifier of the PIB device associated with the electronic device.

14. The method of claim 13, further comprising:
transmitting a query signal, wherein the query signal is received by the PIB device, and the PIB device transmits the signal including the identifier associated with the electronic device in response to the query signal.

15. The method of claim 13, wherein the PIB device transmits the signal including the identifier associated with the electronic device periodically.

16. The method of claim 13, wherein the signal is transmitted within a packet.

17. The method of claim 14, wherein the packet is formed and transmitted according to Internet control message protocol (ICMP).

18. The method of claim 13, wherein the identifier comprises an IP address of the PIB device.

19. The method of claim 13, wherein the identifier is programmed to include physical location information of the PIB device.

20. The method of claim 13, wherein the identifier is programmed to include an identification of the electronic device.

21. The method of claim 13, wherein the identifier is transmitted over a sub-wire that is not used for other network traffic.

22. The method of claim 13, wherein the identifier is transmitted over a sub-wire that is used for other network traffic.

23. A device for detecting location, comprising:
an interface coupled to a network configured to receive a signal including an identifier associated with an electronic device from the network, the signal being transmitted by a patch identification beacon (PIB) device coupled to the network, wherein the PIB device comprises:
a first interface configured to receive signals from the network, and transmit signals to the network, a second interface coupled to the electronic device and a controller configured to govern the first interface to transmit the signal including the identifier of the PIB device associated with the electronic device.
